(19) United States
(12) Patent Application Publication
(10) Pub. No.: US 2004/0247752 A1
(43) Pub. Date: Dec. 9, 2004

(54) Tubular food envelope containing starch and having a transferable coating, and method for producing the same

(76) Inventors: Martina Koenig, Wiesbaden (DE); Bernhard Feron, Wiesbaden (DE); Ulrich Delius, Wiesbaden (DE); Monif Naief, Geisenheim (DE); Hans-Gerd Ziemes, Krefeld (DE)

Correspondence Address: CONNOLLY BOVE LODGE & HUTZ LLP, SUITE 800, 1990 M STREET NW, WASHINGTON, DC, 20036-3425, US

(21) Appl. No.: 10/490,507

(22) PCT Filed: Sep. 18, 2002
(86) PCT No.: PCT/EP02/10445

(30) Foreign Application Priority Data
Sep. 25, 2001 (DE) 101 47 155.6

(51) Int. Cl. A23G 1/00

(52) U.S. Cl. 426/135

(57) ABSTRACT

A seamless, tubular food casing produced by extrusion or coextrusion, wherein at least one layer of the casing comprises a mixture of: a) thermoplastic starch and/or a thermoplastic starch derivative and b) at least one further polymer, in which the further polymer is a homopolymer or copolymer comprising at least one selected from the group consisting of hydroxycarboxylic acid units, a poly(ester urethane), a poly(ether urethane), a poly(ester ether urethane) and a poly(alkylene carbonate) of the formula —[CHR¹—CHR²—O—CO—O—]ₙ, where R¹ and R2 independently of one another are a hydrogen atom or a (C₁-C₄)alkyl group and n is an integer from 10 to 5000, and wherein the casing carries internally at least one transferable coloring, aroma substance and/or flavoring.

The invention relates to a single-layer or multilayer tubular food casing, with the casing, or at least one layer lying on the surface of the casing, comprising a mixture of a) thermoplastic starch or a thermoplastic starch derivative and b) at least one other natural or synthetic polymer. The invention further relates to a method for producing the casing.

Food casings, especially sausage casings, frequently consist of natural sausage skin or of collagen which is likewise obtained from animal sources. However, after the occurrence of animal diseases (BSE), there are prejudices against casings made of such material, and in some countries their use has even been already forbidden. In parallel thereto, casings made of possibly fiber-reinforced regenerated cellulose or of synthetic polymers have become widespread. However, casings made of regenerated cellulose are produced in complex and environmentally polluting methods. Casings made of synthetic polymers, in turn, are generally only slightly permeable to oxygen and/or water vapor. They are generally also impermeable to cold or hot smoke. Casings made of other materials, for example of protein-or acrylate-coated fabric, in contrast, are of only minor importance.

Casings are also disclosed which are produced using thermoplastic starch or a thermoplastic starch derivative (EP-A 709 030). The starch or the starch derivative are generally mixed with a polymer obtainable by polycondensation or polyaddition (EP-A 1 054 599), in particular with a poly(ester urethane) (DE-A 198 22 979).

Food casings are likewise disclosed which have a coating containing constituents which are transferable to the food. Thus WO 98/31731 and EP-A 986 957 disclose films which, on the side facing the food, have a layer containing a flavor component or aroma component and a polysaccharide or protein as binder. The supporting layer of the film consists of polyolefin, polyamide, polyester, poly(vinylidene chloride) (PVDC), poly(vinyl chloride) (PVC) or polystyrene.

JP-A 139401/2000 describes a film by means of which a food color may be transferred to sausagemeat emulsion, ham or similar foods. This is achieved using a coating which, in addition to the food dye, also contains an edible plasticizer, such as glycerol, sorbitol or propylene glycol.

The subject matter of DE-A 198 46 305 is a barrier casing made of a plastics material which, on the inside, has a layer of an absorbent material (woven fabric, knitted fabric or knitwear) which is impregnated with colorings or aroma substances. During boiling or scalding, the colorings or aroma substances are transferred to the food enclosed by the casing. The inner layer is generally joined to the adjacent layer of the casing by an adhesive. The barrier casing itself consists, for example, of polyamide and polyethylene layers. Tubular casings are generally produced from corresponding flat films by hot sealing or gluing. In the area of the seal seam, the coloring or aroma substance is frequently transferred unevenly. Also, sealed or glued casings frequently exhibit uneven shrinkage. Then, after the scalding or boiling, the sausage, in the seam areas, exhibits an unwanted gel deposition between casing and sausagemeat emulsion.

Tubular cellulose-based food casings which, on the side facing the food, carry smoke and/or spices, have already been described. These casings have a high permeability for water vapor and oxygen. A food situated in the casing therefore dries out relatively rapidly and has only a short shelf life.

However, all the known casings having an inner layer or inner coating which contains a transferable food additive generally exhibit the disadvantage that the adhesion of the layer cannot be set in the manner desired. The consequence of insufficient adhesion is that the sausage has a tendency toward gel formation and that the coating, during final processing into a form ready for the user (in the case of tubular films, usually by shirring and/or reversing), exhibits cracks or even flakes off. The casings can then no longer be used. If adhesion is too high, coloring, aroma substance or flavoring is not transferred to the food in a sufficient extent.

It is an object of the present invention, therefore, to provide a seamless tubular food casing which has good barrier properties, in particular a high barrier to oxygen and water vapor, and by means of which it is possible to transfer colorings, aroma substances or flavorings uniformly to a food in contact with the casing. It is to be possible to produce the casing as simply and inexpensively as possible, ideally without gluing or laminating. When the sausages are boiled or scalded no gel deposit is to be formed.

We have found that this object is achieved by a multilayer casing, the inner layer of which comprises thermoplastic starch or a thermoplastic starch derivative, mixed with at least one other thermoplastic polymer. The inner layer adheres very well to the adjacent layer of the casing, it absorbs the colorings, aroma substances or flavorings intensively and releases them later to the food. The casing is to be usable, in particular, for producing cooked-meat and scalded-emulsion sausages, and also raw sausages.

The present invention therefore relates to a single-layer or multilayer, seamless, tubular food casing, the casing or at least the inner layer of the casing comprising a mixture of a) thermoplastic starch and/or a thermoplastic starch derivative and b) at least one further polymer, in which the casing carries internally at least one transferable coloring, aroma substance and/or flavoring.

Preferably, the casing is a multilayer casing. The further layer(s) are generally what are termed barrier layers which are less permeable to gas and water vapor than the layer comprising starch or starch derivatives. They retard drying out of the food during storage and prevent the ingress of atmospheric oxygen. This object can be achieved by layers based on polyamide, polyolefin, polyester, poly(vinylidene chloride) (PVDC), poly(vinyl chloride) (PVC), polystyrene or based on corresponding copolymers. Layers based on polyamide or polyolefin are generally preferred. The polyamide layers can comprise aliphatic polyamide, aliphatic copolyamide, or a mixture thereof. Examples of these are polycaprolactam (nylon 6), poly(hexamethylene adipamide) (nylon 66) and a copolyamide of caprolactam, hexamethylenediamine and adipic acid units (nylon 6/66). In addition, the polyamide layers can comprise partially or completely aromatic polyamides, for example a copolyamide of hexamethylenediamine, terephthalic acid and isophthalic acid (nylon 6I/6T). The content of the (partially) aromatic polyamides is generally no more than 40% by weight, based on the total weight of the polyamide layer.

Furthermore, the polyamide layers can also comprise other polymers, for example polyolefins, polyesters or ionomers. The content of the other polymers is preferably not more than 25% by weight, based on the total weight of the relevant polyamide layer.

The polyolefin layers generally consist of polyethylene, polypropylene or copolymers containing units of polyethylene, polypropylene and/or α-olefins having from 4 to 8 carbon atoms. Suitable compounds are, in particular, C₂/C₃- and C₃/C₄-copolymers, C₂/C₃/C₄-terpolymers and mixtures thereof.

It is necessary to take into account the fact that polyamide layers exhibit a high oxygen barrier, but only a relatively low water vapor barrier. In the case of polyolefin layers, the situation is exactly the reverse. If a particular barrier action is to be achieved, it is expedient, therefore, to provide simultaneously at least one polyamide layer and at least one polyolefin layer. Between the barrier layers, expediently, there are further situated relatively thin (from 0.5 to 5 μm after stretching) adhesion layers. They consist of, or comprise, an adhesion promoter. Suitable adhesion promoters are, in particular, graft polymers or copolymers (the term “copolymers” also comprising polymers having more than two different monomer units) containing ethylene units and/or propylene units and units of at least one comonomer from the group consisting of (meth)acrylic acid, (meth)acrylic ester, vinyl acetate and maleic anhydride. Preferred comonomers are, in particular, C₁-C₆)alkyl (meth)acrylates, such as butyl acrylate. Rubber-modified polyethylene is also suitable. The content of units containing functional groups in the graft or copolymers is generally from 3 to 12% by weight, based on the weight of the adhesion-promoting component. The term “(meth)acrylic acid” and “(meth)acrylate” here means acrylic acid and/or methacrylic acid, or acrylate and/or methacrylate, respectively.

Particular preference is given to casings which, before reversal, have the following structure (“starch” can also mean here “starch derivative”):

| | |
|---|---|
| inside | outside |

(starch + further polymer)/(polyolefin + adhesion
promoter)/polyamide
(starch + further polym.)/adhesion l./polyolefin/adhesion
l./polyamide
(starch + further polym.)/adhesion l./polyamide/adhesion
l./polyolefin/adhesion l./polyamide
(starch + further polym.)/adhesion l./EVOH/adhesion
l./polyolefin/adhesion l./polyamide
(starch + further polym.)/polyamide/adhesion
l./polyolefin/adhesion l./polyamide
(starch + further polym.)/polyamide/(polyolefin + adhesion
promoter)/polyamide
(starch + further polym.)/EVOH/(polyolefin + adhesion
promoter)/polyamide

An adhesion layer can therefore also be disposed between the starch-or starch derivative-containing layer and one of further layers of the multilayer casing. Whether such an intermediate layer is expedient depends here just as on the type and content of the further polymers in the starch-or starch derivative-containing layer, as on the type of the adjacent layer. Individual adhesion layers can also be omitted if the adhesion-promoting components present therein are mixed with the components of an adjoining layer. Thus, it has proved expedient to incorporate adhesion promoters into the polyolefin layer, possibly also into a polyamide layer. This gives overall a simpler structure having a fewer number of layers.

The inventive food casing can be stretched with an area ratio of from 1:2 to 1:10, which is preferably achieved by film blowing. This applies to the single-layer and also to the multilayer embodiment. The thickness of the stretched film (without the coating) is generally from 30 to 120 μm, preferably from 40 to 90 μm. However, preferably, the film is not stretched.

The weight ratio of thermoplastic starch and/or thermoplastic starch derivative to the at least one other polymer obtainable by polycondensation or polyaddition is expediently from about 90:10 to 10:90, preferably from 20:80 to 80:20, particularly preferably from 20:80 to 40:60.

The thermoplastic starch derivative is preferably a starch ester, as described extensively in DE-A 195 15 477. The acid component in the ester is generally a (C₂-C₁₀)alkanoic acid, which is preferably unbranched or only slightly branched. A particularly preferred and inexpensive starch alkanoate is starch acetate, in particular that having a degree of substitution of less than 3, especially of from 1.5 to 2.4. Differently from starch itself, starch esters, such as the starch acetate, are already thermoplastic as such and need not be first plasticized. Starch esters having a longer alkyl chain, for example starch hexanoates, octanoates or decanoates, produce a change in suppleness and toughness, and also in the permeation of the food casings. By combining various starch esters, casings having particularly specific properties can be produced. Thermoplastic starch derivatives having cationic quaternary side groups containing hydrophobic (C₂-C₁₈)alkyl groups, preferably (C₂-C₁₂)alkyl groups, are also suitable. To modify the casing properties further, fibers or fillers can also be further incorporated into the layer comprising starch or starch derivatives.

It has been found that food casings which consist solely of thermoplastic starch and/or thermoplastic starch derivatives do not yet have the desired extent of extensibility, strength, toughness, suppleness, but especially stability to hot or boiling water. These properties are not achieved until the thermoplastic starch or the starch derivative is mixed with other polymers obtainable by polycondensation or polyaddition.

The polymer obtainable by polycondensation is preferably a homopolymer or copolymer containing hydroxycarboxylic acid units. Particular preference is given to a polylactide, poly(3-hydroxypropionic acid), poly(3-hydroxybutyric acid), poly(4-hydroxybutyric acid), polycaprolactone, poly(ether urethane)s and poly(ester ether urethane)s, poly(alkylene carbonate)s of the formula —[CHR¹—CHR²—O—CO—O—]ₙ, where R¹ and R² independently of one another are a hydrogen atom or a (C₁-C₄)alkyl group and n is an integer from 10 to 5000. Particularly suitable poly(alkylene carbonate)s are poly(ethylene carbonate) (R¹=R²=H) and poly(propylene carbonate) and mixtures thereof. The poly(alkylene carbonate)s are described, for example, in WO 96//35746. A preferred polymer which is obtainable by polyaddition is poly(vinyl acetate). The polycondensation or polyaddition products may be produced synthetically by known methods. They are customarily not crosslinked or only very slightly crosslinked. Their mean molecular weight M_{w} is generally from 20 000 to 2 000 000, preferably from 100 000 to 1 000 000. It is assumed that the polycondensates form a type of matrix in which the thermoplastic starch, and thus the unstructured starch, or the starch derivative, is uniformly distributed.

In a particularly preferred embodiment, the further polymer is a thermoplastic poly(ester urethane) as described in DE-A 198 22 979. The thermoplastic poly(ester urethane) generally consists of hard polyurethane segments and soft polyester segments, the segments being arranged in alternating sequence. “Soft” here denotes segments having a glass transition temperature (T_{g}) of −20° C. or below, and “hard” in contrast denotes those having a T_{g} of +30° C. or above. The poly(ester urethane) can be of aliphatic or aromatic nature. The content of the polyurethane segments in the thermoplastic poly(ester urethane) is from 10 to 90% by weight, preferably from 20 to 50% by weight, in each case based on the total weight of the poly(ester urethane). They generally consist of diisocyanate and diol units. The diisocyanate units can be aliphatic, cycloaliphatic or aromatic. Examples of aliphatic diisocyanates are butane 1,4-diisocyanate and hexane 1,6-diisocyanate. Isophorone diisocyanate (=3-isocyanatomethyl-3,5,5-trimethylcyclohexane isocyanate) is a cycloaliphatic diisocyanate. Toluene 2,4- and 2,6-diisocyanate, diphenylmethane 2,2′-, 2,4′-, 2,6′- and 4,4′-diisocyanate and also naphthalene 1,5-diisocyanate are preferred aromatic diisocyanates.

The polyester segments generally have a mean molar mass M_{w} of from 500 to 10 000 g/mol, preferably from 1000 to 4000 g/mol. They preferably consist of units of dihydric or polyhydric alcohols and units of dibasic or polybasic carboxylic acids. They may be prepared from said starting materials by condensation polymerization in the presence of catalysts, such as titanium butoxide (=orthotitanic acid tetrabutyl ester). However, usually, the polyester segments consist of diol units and dicarboxylic acid units. Of course, instead of the free acids, corresponding acid derivatives, such as carbonyl halides (in particular carbonyl chlorides), carboxylic anhydrides or carboxylic (C₁-C₄)alkyl esters can alternatively be used in the condensation reaction. The diols or polyols generally have an aliphatic or cycloaliphatic backbone. Preferred diols for preparing the ester segments are ethane-1,2-diol (=ethylene glycol), propane-1,2- and -1,3-diol, 2,2-dimethylpropane-1,3-diol (=neopentyl glycol), butane-1,4-diol, pentane-1,5-diol, hexane-1,6-diol and cyclohexanediylbismethanol (in particular cyclohexane-1,4-diylbismethanol). Mixtures of a plurality of different diols or polyols can also be used. The di-or poly(carboxylic acid)s preferably likewise have an aliphatic or cycloaliphatic backbone, aliphatic dicarboxylic acids (such as succinic acid or adipic acid) being preferred. Particular preference is given to adipic acid. A dicarboxylic acid having a cycloaliphatic backbone is, for example, cyclohexanedicarboxylic acid (in particular cyclohexane-1,4-dicarboxylic acid). The polyester segments can also be made up of units of hydroxycarboxylic acids or derivatives thereof, for example from 3-hydroxypropionic acid, 3-hydroxybutyric acid, 4-hydroxybutyric acid, 5-hydroxypentanoic acid or ε-caprolactone. Compounds which are particularly suitable are poly(ester urethane)s which, at a temperature of 190° C. and a load of 21.6 kg, have a melt volume index MVI (determined in accordance with ISO 01133) in the range of from about 5 to 15 cm³/10 min.

The layer containing starch or starch derivatives can additionally contain further low-molecular-weight or high-molecular-weight constituents, which in particular act as plasticizers or lubricants, or improve the compatibility of the components with one another. By means of the further constituents, the homogeneity or flowability of the extrudable thermoplastic mixture can if appropriate be further improved. Suitable plasticizers are, particularly, glycerol, diglycerol, sorbitol, poly(ethylene glycol) (PEG), citric acid triethyl ester, acetylcitric acid triethyl ester, glycerol triacetate, phthalic acid ester (especially dimethyl phthalate, diethyl phthalate and dibutyl phthalate) and also sorbitol mono- or diesters. The content of plasticizer(s) is up to 30% by weight, preferably up to 15% by weight, in each case based on the total weight of the layer. Lubricants which improve the homogeneity of the thermoplastic mixture are, in particular, vegetable fats or oils, synthetic triglycerides, lecithins, ethoxylated fatty alcohols or waxes. The content of the lubricants is up to 12% by weight, preferably from 2 to 6% by weight, particularly preferably from 3 to 6% by weight, in each case based on the total weight of the layer.

For casings having a particularly high stability toward hot or boiling water, it has proved to be expedient to add in addition crosslinkers to the thermoplastic mixture. Suitable crosslinkers are, for example, dicarboxylic acids, di- or triisocyanates (particularly hexamethylene diisocyanate), dialdehydes (particularly glyoxal), diepoxides, diimines or silanes or siloxanes containing vinyl group(s), for example vinyltrimethylsilane. The crosslinker is preferably not added until the remaining components of the mixture are already molten. The content of crosslinker(s) is up to 20% by weight, preferably from 0.5 to 10% by weight, particularly preferably from 1 to 5% by weight, in each case based on the total weight of the thermoplastic mixture.

The preparation of thermoplastic starch is known and is described in WO 90/05161 and 90/10019. During the plasticizing, the helix structure of the native starch is abolished. The starch is then in an amorphous state. Plasticization is generally performed by heating and supplying mechemical energy, for example by relatively long thermal treatment in a kneader or in a single-or double-screw extruder. In order that the starch melts below its decomposition temperature, additives are necessary, such as water, 1,3-butanediol, glycerol, diglycerol, N,N-dimethylurea, sorbitol or citrate. During the plasticization with water, from about 20 to 25% by weight of water, preferably about 17% by weight of water, are added, in each case based on the weight of the native starch. A temperature of from about 100 to 190° C. is maintained. During the plasticization with glycerol, a content of from 0.5 to 20% by weight, preferably from 8 to 16% by weight, in turn in each case based on the weight of the native starch, at a temperature of from 150 to 210° C. have proved expedient. This treatment reduces the content of crystalline starch to 5% by weight or below.

The thermoplastic mixture may be produced from said components in conventional apparatuses, for example in a twin-screw kneader. To form a homogeneous thermoplastic melt from the mixture, a temperature of from 90 to 200° C., preferably from 120 to 180° C., has proved expedient. The melt can be extruded, comminuted after cooling and stored temporarily as granules or in similar form, and can equally well also be processed directly to form a food casing. The tube produced from the melt described is then inflated with air in the film-blowing process, and in the process stretched longitudinally and transversely in an area ratio of from 1:2 to 1:10, preferably from 1:3 to 1:5. The tubes only achieve optimal strength, extension, caliber constancy and shrinkage by the stretching. The extent to which each of these properties is expressed primarily depends on the composition of the thermoplastic mixture. Thus the food casings can be adapted to the most varied requirements by targeted selection of the components of the thermoplastic mixture, of the stretching conditions and of the type of post-treatment. If appropriate, the blown casings can also be partially heat set.

Multilayer tubular casings may also be produced by coextrusion using suitable ring dies or by other methods generally known to those skilled in the art.

In a further method step, the colorings, aroma substances and/or flavorings are applied to the tubular casing. A number of methods are in turn available for this, for example spraying, printing, roller application, flocking, calendering or painting. A plurality of the methods can also be combined. It has proved to be particularly expedient to produce the multilayer tubular casing first in such a manner that the layer produced with the thermoplastic starch or the thermoplastic starch derivative lies on the outside. Then the coloring, aroma substance and/or flavoring is applied to this layer. Then the casing is reversed, so that the originally outside layer then forms the inside layer. The coloring, aroma substance or flavoring can also be applied to the single-layer casing in virtually the same manner. Methods and apparatuses for reversing sausage casings are generally known to those skilled in the art. This procedure is particularly expedient, because applying additives to the outside is considerably simpler and cheaper in processing terms. The reversed casing is then shirred in sections in a likewise known manner. The inventive casing has the surprising advantage that the coating on the layer containing starch or starch derivative is considerably better than on a layer of other material, such as a polyamide or polyolefin layer. Only by this means is it possible to reverse the casing without impairing the coating.

The coloring, aroma substance or flavoring is, for example, a spice or a spice mixture (for example pepper in whole corns or ground), a spice extract, liquid smoke or dry smoke which can also be modified (for example by adding alkaline compositions and/or viscosity-increasing compositions or by removing tar constituents), a natural or synthetic aroma, a flavor enhancer (for example glutamine) or another food additive. Liquid smoke, for example, is absorbed in the layer containing starch or starch derivative. Solid substances, in contrast, are generally bound to the surface of the layer, expediently using binders.

Therefore, in a preferred embodiment, the coloring, aroma substance or flavoring is combined with a binder permitted by law for food use, in particular a polysaccharide (such as starch), a modified starch (such as carboxymethyl starch), dextran, pullulan, tragacanth gum, xanthan gum, gum arabic, alginate, methyl cellulose, hydroxyethyl cellulose, hydroxypropyl cellulose, carboxymethyl cellulose, chitin, chitosan, a protein (such as gluten), pectin, carrageenan, guar or gelatin. The type and amount of the binder or binder mixture depend on the coloring, aroma substance or flavoring and may be optimized in simple preliminary experiments. The binder can be mixed with the coloring, aroma substance or flavoring. In some cases, if whole pepper corns or coarsely ground pepper is to be applied, it is expedient to provide first a layer of the binder and then to apply the colorings, aroma substances or flavorings alone or mixed with further binder. The thickness of the binder layer depends on the type of component to be transferred.

To achieve uniform transfer of the colorings, aroma substances or flavorings during boiling or scalding of the food, it has furthermore proved to be particularly expedient to add to the coloring, aroma substance or flavoring and/or the binder a component which reduces the water solubility. Particularly suitable for this purpose is shellac, especially sheet shellac.

The inventive food casing is particularly suitable for producing cooked-meat sausage or scalded-emulsion sausage, but also for (boiled) ham, cured goods and even for process cheese. The food, due to the constituents transferred from the casing, is modified in appearance, odor or flavor. In particular, the casing can impart smoked color and aroma to the food.

In the examples hereinafter, percentages are to be taken as percentages by weight, unless stated otherwise.

### EXAMPLE 1

a) Production of Thermoplastic Starch

100 kg of potato starch were dried under reduced pressure to a water content of less than 0.3% and melted with 50 kg of glycerol (99% pure) in a kneader at from 160 to 190° C. and mixed thoroughly.

To abolish the helix structure of the starch, the melt was kept at 170° C. for about 2 h. It was then extruded and granulated. During the subsequent storage of the granules, the starch remained in the amorphous state, and thus thermoplastic state.

b) Production of a Seamless Multilayer Food Casing

75 kg of the granules described under a) (50 kg of starch+25 kg of glycerol) were mixed with 50 kg of polycaprolactone, 3 kg of sunflower seed oil and 3 kg of hexamethylene diisocyanate. The components which were uniformly mixed with one another were melted in an extruder at 150° C.

In one further single-screw extruder in each case, a) a mixture of 70% aliphatic polyamide (®Grilon F40) and 30% partially aromatic polyamide containing units of hexamethylnediamine, isopthalic acid and terephthalic acid (PA 6I/6T; ®Grivory G21) and b) a mixture of 80% LLDPE and 20% adhesion promoter (ethylene/methacrylic acid copolymer) were melted.

The individual melts were then combined in a coextrusion ring die and coextruded. The diameter of the ring die was selected so that, after film blowing in an area ratio of 1:8.5, a tube having a diameter of 60 mm (=caliber 60) and a wall thickness of 80 μm was obtained. In this tube, the starch-containing layer formed the outer layer (thickness: 20 μm), the polyolefin layer formed the central layer (thickness: 25 μm) and the polyamide layer formed the inner layer (thickness: 35 μm).

On the outside of the casing, then, using a doctor blade, a mixture of

| | |
|---|---|
| 79.8% | ethanol, |
| 2.6% | shellac, |
| 3.0% | polyvinylpyrrolidone, |
| 8.0% | of a liquid smoke from Zesti Smoke, made |
| | alkaline, |
| 1.6% | of a brown food dye (Eurolake Brown HT), |
| 1.0% | alginate (® Protanal XLRB from Protan AS, |
| | Norway) and |
| 0.2% | citral |

was applied and dried. The casing was then reversed and shirred in sections to form shirred sticks.

The casing was then stuffed with sausagemeat emulsion for scalded-emulsion sausage on an automatic stuffing and portioning machine. During the subsequent scalding of the sausage, the smoked color was transferred to the sausagemeat emulsion uniformly without spots.

### EXAMPLE 2

A blend was produced from 50 kg of starch acetate having a degree of substitution of 2.2 and a molar mass of 580 g/mol which were mixed with 50 kg of poly(ethylene carbonate) having a molecular weight M_{w} of 500 000 and were admixed with 15 kg of citric acid triethyl ester. This mixture was admixed with 8 kg of thermoplastic starch, 5 kg of 1,2;5,6-diepoxyhexane (hexamethylene diepoxide) and 5 kg of ethoxylated octadecanol (stearyl alcohol), mean 12 ethylene oxide units.

This mixture was melted in a twin-screw extruder at from 150 to 190° C., mixed thoroughly and then extruded through a ring die, the dimensions of which were selected in such a manner that, after film blowing in an area ratio of 1:8, a seamless tube was obtained of caliber 70 having a wall thickness of 90 μm.

Then, to the outside of the casing, a mixture of

| | |
|---|---|
| 33.0% | of a 4% strength aqueous NaOH solution, |
| 8.0% | shellac, |
| 7.0% | of a liquid smoke from Zesti Smoke, made |
| | alkaline, |
| 50.0% | water, |
| 1.0% | alginate, |
| 1.0% | silica, |
| 1.0% | of a brown food dye (Eurolake Brown HT), |
| | and |
| 0.1% | citral |

was applied using a doctor blade, and dried.

As described in Example 1, the casing was then reversed, shirred in sections and stuffed with sausagemeat emulsion for scalded-emulsion sausage. Here also, the smoked color had been transferred uniformly and without spots to the emulsion after the sausage had been scalded.

1. A seamless, tubular food casing produced by extrusion or coextrusion, at least wherein at least one layer of the casing, comprises a mixture of:
a) thermoplastic starch and/or a thermoplastic starch derivative and
b) at least one further polymer, in which the further polymer is a homopolymer or copolymer comprising at least one selected from the group consisting of hydroxycarboxylic acid units, a poly(ester urethane), a poly(ether urethane), a poly(ester ether urethane) and a poly(alkylene carbonate) of the formula —[CHR¹—CHR²—O—CO—O—]ₙ, where R¹ and R2 independently of one another are a hydrogen atom or a (C₁-C₄)alkyl group and n is an integer from 10 to 5000, and
wherein the casing carries internally at least one transferable coloring, aroma substance and/or flavoring.

2. The food casing as claimed in claim 1, wherein the weight ratio of thermoplastic starch and/or thermoplastic starch derivative to the further polymer is from 90:10 to 10:90.

3. The food casing as claimed in claim 1, wherein the thermoplastic starch derivative is a starch ester.

4. The food casing as claimed in claim 1, wherein the polymer b) comprises a polylactide, a poly(3-hydroxypropionic acid), a poly(3-hydroxybutyric acid), a poly(4-hydroxybutyric acid) or polycaprolactone.

5. The food casing as claimed in claim 1, wherein said casing is multilayered.

6. The food casing as claimed in claim 5, wherein the further layer are barrier layers.

7. The food casing as claimed in claim 6, wherein at least one polyamide layer and at least one polyolefin layer are present.

8. The food casing as claimed in claim 1, wherein the coloring, aroma substance and/or flavoring is a spice or a spice mixture, a spice extract, a liquid smoke or dry smoke, a natural or synthetic aroma and/or a flavor enhancer.

9. The food casing as claimed in claim 1, wherein the coloring, aroma substance or flavoring is combined with a binder permitted by law for food use.

10. The food casing as claimed in claim 9, wherein the binder is a polysaccharide, a modified starch, dextran, pullulan, tragacanth gum, xanthan gum, gum arabic, alginate, methyl cellulose, hydroxyethyl cellulose, hydroxypropyl cellulose, carboxymethyl cellulose, chitin, chitosan, a protein, pectin, carrageenan, guar or gelatin.

11. The food casing as claimed in claim 1, wherein a component which decreases the water solubility is present in addition to the coloring, aroma substance or flavoring and/or to the binder.

12. The food casing as claimed in claim 11, wherein the component which reduces the water solubility is shellac.

13. A method for producing the food casing comprising
1) providing a casing which comprises a mixture of a) thermoplastic starch and/or a thermoplastic starch derivative and b) at least one further polymer,
2) applying a coloring, aroma substance and/or flavoring to the outside of the casing and
3) reversing the casing, so that the outside passes to the inside.

14. The method as claimed in claim 13, wherein the coloring, aroma substance and/or flavoring is applied by spraying, printing, roller application, flocking, calendering and/or painting.

15. A method for enveloping cooked-meat sausage or scalded-emulsion sausage, (boiled) ham, cured goods or process cheese comprising employing a casing as claimed in claim 1.

16. The food casing as claimed in claim 5, wherein the further layer comprises at least one layers based on polyamide, polyolefin, polyester, poly(vinylidene chloride) (PVDC), poly(vinyl chloride) (PVC), polystyrene or on corresponding copolymers.

17. A food casing according to claim 1 that is single layered.

18. A food casing according to claim 1 that is multilayered.

19. A method according to claim 13 wherein said casing is single layered.

20. A method according to claim 13 wherein said casing is multilayered.
